(19) United States
(12) Patent Application Publication
(10) Pub. No.: US 2013/0299506 A1
(43) Pub. Date: Nov. 14, 2013

(54) BUCKET WITH INTERIOR FUNNEL

(71) Applicants: Sebastian Chavez, Wichita, KS (US); Sage Marler, Woodland Park, CO (US)

(72) Inventors: Sebastian Chavez, Wichita, KS (US); Sage Marler, Woodland Park, CO (US)

(21) Appl. No.: 13/781,053

(22) Filed: Feb. 28, 2013

Related U.S. Application Data
(60) Provisional application No. 61/604,367, filed on Feb. 28, 2012.

(51) Int. Cl. B67D 7/78

(52) U.S. Cl. CPC B67D 7/78
USPC 220/600; 220/729

(57) ABSTRACT

A bucket with a funnel shape inside toward the center of the bottom of the bucket. The funnel shaped inside bottom makes a received product material funnel to the center, making it easy to siphon the majority of the product material inside the bucket.

### CROSS REFERENCE TO RELATED APPLICATION

This application claims the benefit of U.S. Provisional Patent Application No. 61/604,367, filed Feb. 28, 2012, the entirety of which is hereby incorporated by reference into this application.

### BACKGROUND OF THE INVENTION

1. Field of the Invention

The present invention relates to a bucket which includes an interior funnel for directing a received material to a central location.

2. Description of Related Art

It has been found that when a paint sprayer is in a conventional five gallon bucket it cannot siphon an entire amount of the material held in the bucket, since the bottom is flat. The large surface of the flat five gallon bucket retains material away from the center. Accordingly, the conventional flat bottomed bucket does not allow one to utilize the entire amount of the product contained inside the bucket. It is desirable to provide an improved bucket to allow one to utilize substantially the entire amount of a product contained inside the bucket.

### SUMMARY OF THE INVENTION

The present invention relates to a bucket including a funnel shaped inside bottom. The funnel shaped inside bottom makes a received material funnel to the center, thereby making it easy to siphon the majority of the material inside the bucket. The bucket of the present invention provides improved siphoning of the material from the bucket.

A handle is attached to the bucket. A handle grip is coupled to the handle. The hand grip is used to grab the handle to help carry the entire bucket or tilt it to pour out the material inside the bucket.

The invention will be more fully described by reference to the following drawings.

### BRIEF DESCRIPTION OF THE DRAWINGS

FIG. 1 is a schematic cross sectional view of a bucket with interior funnel in accordance with the teachings of the present invention.

FIG. 2 is a top plan view of the bucket shown in FIG. 1.

FIG. 3 is a perspective view of the side and top of the bucket including a lid.

FIG. 4A is a schematic diagram of the bucket in combination with a siphon.

FIG. 4B is a schematic diagram of the bucket in combination with an alternate siphon.

FIG. 4C is a schematic diagram of the bucket in combination with an alternate siphon.

FIG. 5A is a schematic perspective front and side view of a bucket in accordance with the teachings of the present invention.

FIG. 5B is an elevational front view of the bucket shown in FIG. 5A.

FIG. 5C is a side elevational view of the bucket shown in FIG. 5A.

FIG. 5D is a bottom plan view of the bucket shown in FIG. 5A.

FIG. 5E is a schematic sectional view of a funnel inside of the bucket.

FIG. 5F is a schematic perspective view of a funnel inside of the bucket.

FIG. 6A is a schematic perspective front and side view of a bucket in accordance with the teachings of the present invention.

FIG. 6B is an elevational front view of the bucket shown in FIG. 6A.

FIG. 6C is a side elevational view of the bucket shown in FIG. 6A.

FIG. 6D is a bottom plan view of the bucket shown in FIG. 6A.

FIG. 6E is a schematic sectional view of a funnel inside of the bucket.

FIG. 6F is a schematic perspective view of a funnel inside of the bucket.

FIG. 7A is a schematic perspective view of a bucket including a removable funnel.

FIG. 7B is a schematic perspective top view of the funnel.

FIG. 7C is a schematic perspective bottom view of the funnel.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

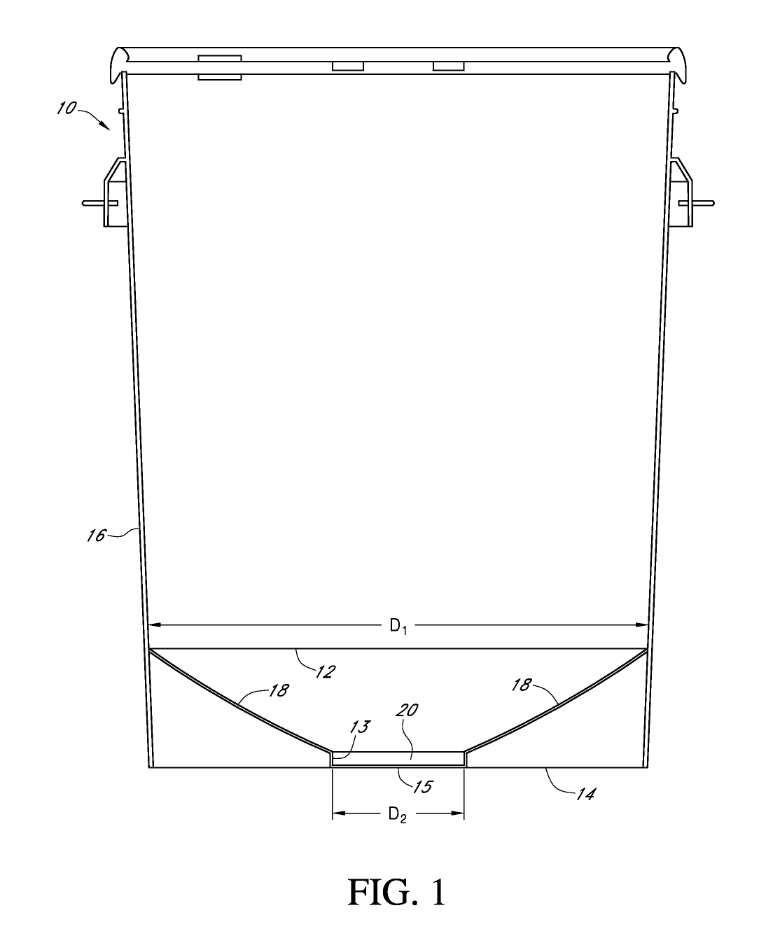

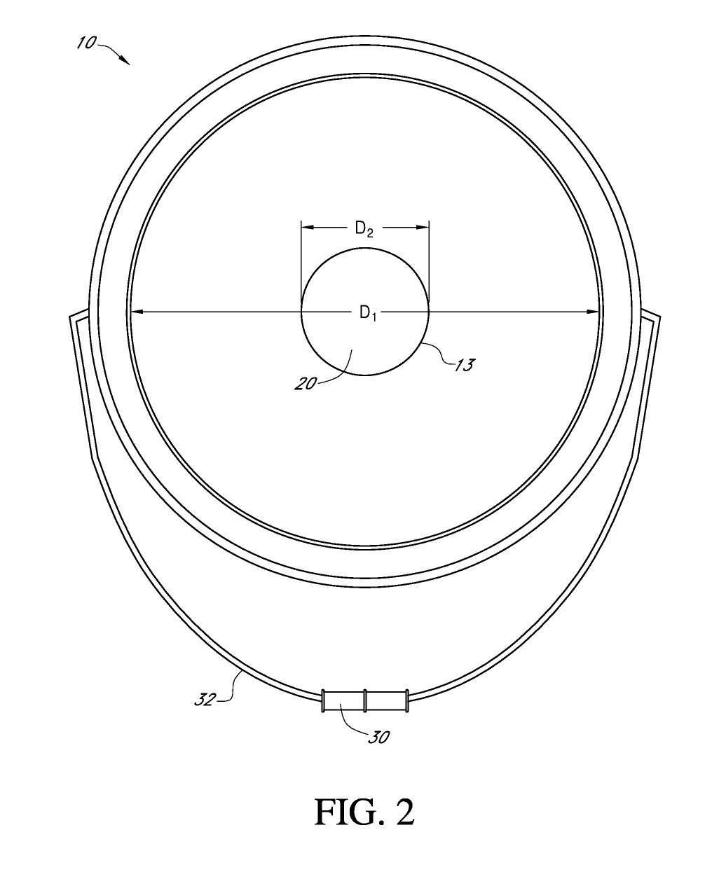

FIG. 1 is a schematic diagram of bucket 10 in accordance with the teachings of the present invention. Bucket 10 includes funnel 12 positioned adjacent bottom 14. Funnel 12 directs a received material downwardly to central section 15 of bottom 14. Diameter D₁ of funnel 12 extends to end sidewall 16 of bucket 10. Sides 18 of funnel 12 slope downwardly to center portion 20. Center portion 20 can have a circular or cylindrical shape. Diameter D₂ of center portion 20 is smaller than diameter D₁, as shown in FIG. 2.

In one embodiment, funnel 12 has a conical or frusto conical shape to outlet 13. Alternatively, funnel 12 has any shape providing a downward slope of sides 18 to center portion 20 of outlet 13.

Funnel 12 can be permanently or removably coupled to bucket 10 to form a funnel shaped bottom of bucket 10. For example, bucket 10 can be substantially a five gallon bucket and funnel 12 can be removably inserted therein. Alternatively, bucket 10 and funnel 12 are integral.

In one embodiment for manufacturing bucket 10, a plastic mold or die is formed in the shape of bucket 10 and funnel 12. A plastic material is poured into the plastic mold or die.

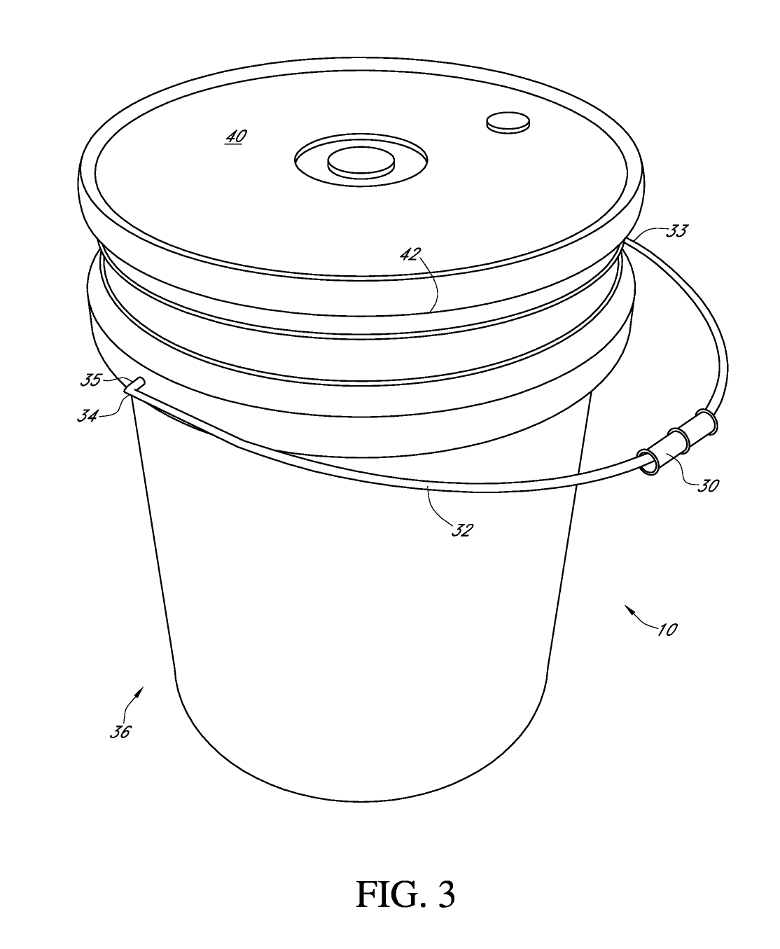

Hand grip 30 is attached or received over handle 32, as shown in FIG. 3. For example, hand grip 30 can be formed of plastic or rubber and handle 32 can be formed of metal, such as aluminum. Ends 34 of handle 32 are received in apertures 35 located on outer sidewall 36 of bucket 10. Hand grip 30 fits on handle 32. Handle 32 can be secured or attached to upper portion 33 of bucket 10. Lid 40 can be removably coupled to rim 42 of bucket 10.

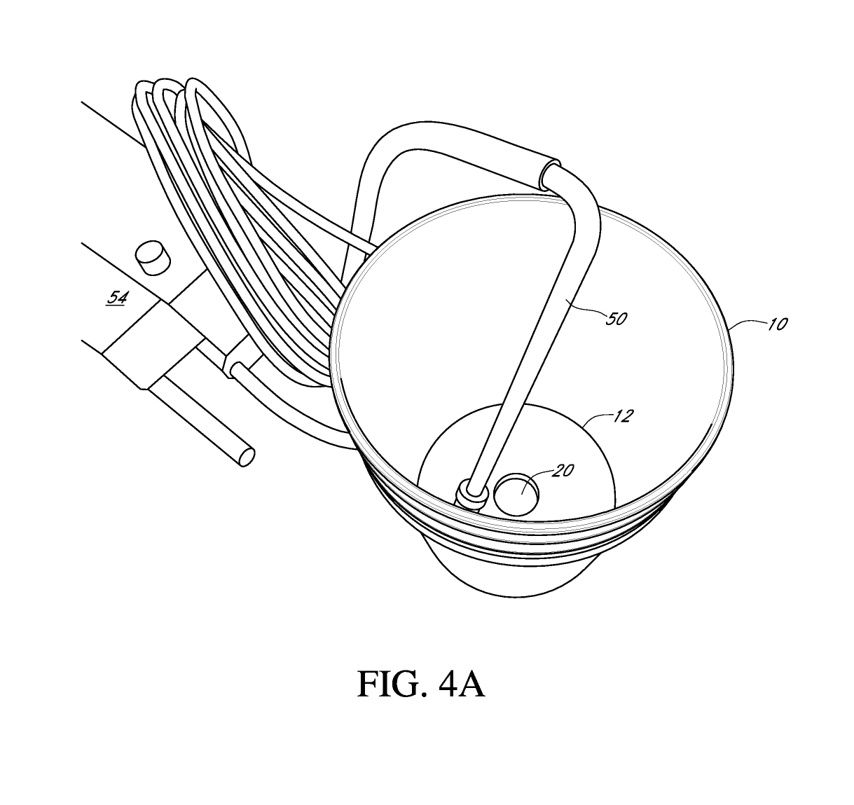

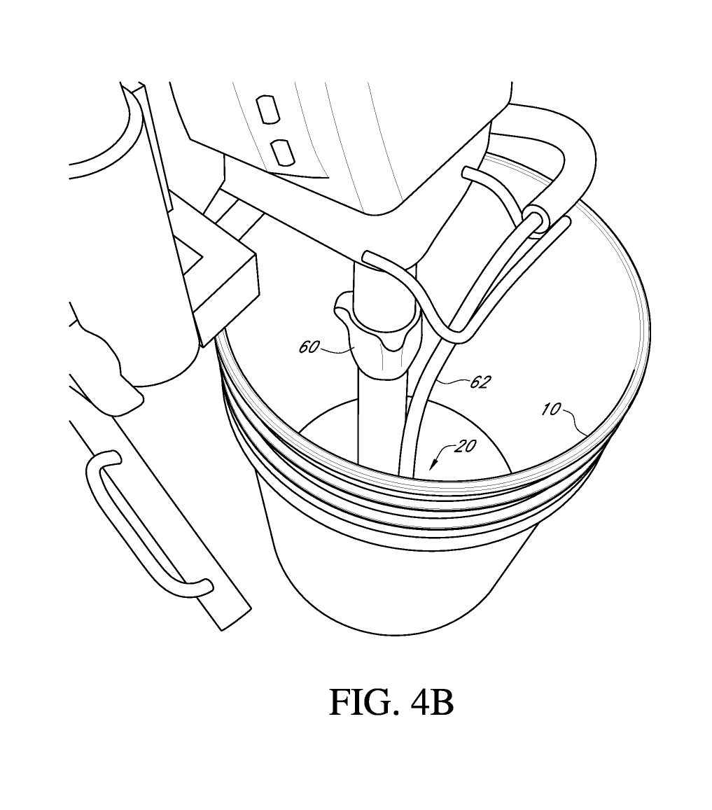

As shown in FIG. 4A, siphon 50 can be inserted into bucket 10 and moved to be arranged within center portion 20 of funnel 12. During operation, siphon 50 is able to siphon liquid material from bucket 10, and in particular all liquid material within bucket 10 flows towards center portion 20 and is siphoned by siphon 50. Siphon apparatus 54 attached to siphon 50 is operated to provide siphoning of material from bucket 10.

In an alternative embodiment, siphon 60 and siphon 62 can be inserted into bucket 10 and arranged adjacent center portion 20 of funnel 12, as shown in FIGS. 4B and 4C. During operation, siphon 60 and siphon 62 are able to siphon liquid material from bucket 10, and in particular all liquid material within bucket 10 flows towards center portion 20 and is siphoned by siphon 60 and siphon 62.

Siphon apparatus 64 attached to siphon 60 and siphon 62 is operated to provide siphoning of material from bucket 10. Siphon 50, siphon 60 and siphon 62 positioned in center portion 20 can siphon the majority of a material received in bucket 10. Siphon 50 and siphon 60 can be any conventional siphon, for example, a siphon used to siphon paint from bucket 10.

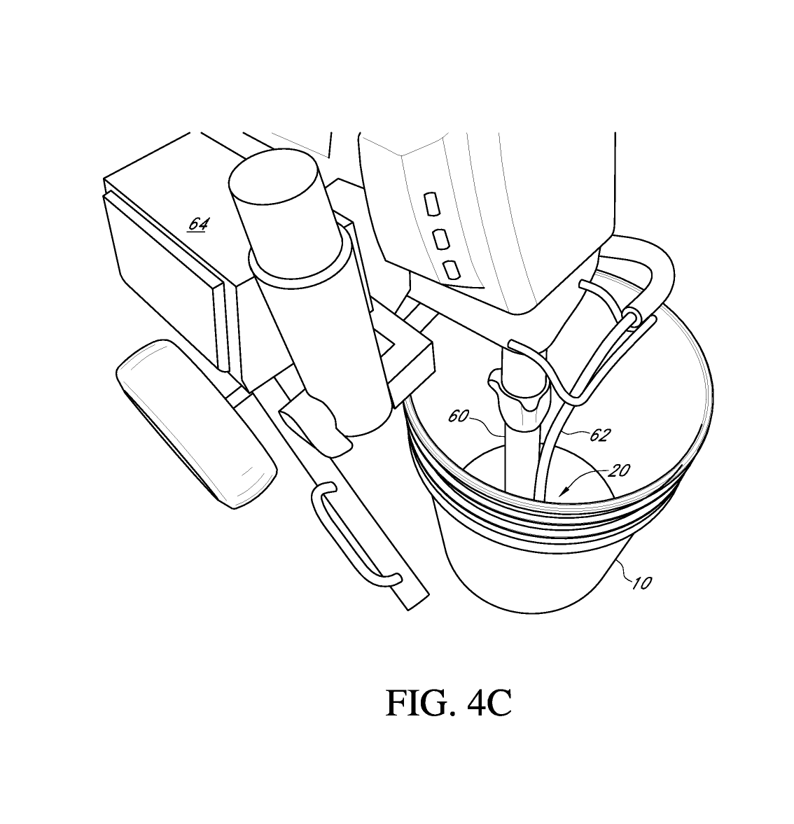

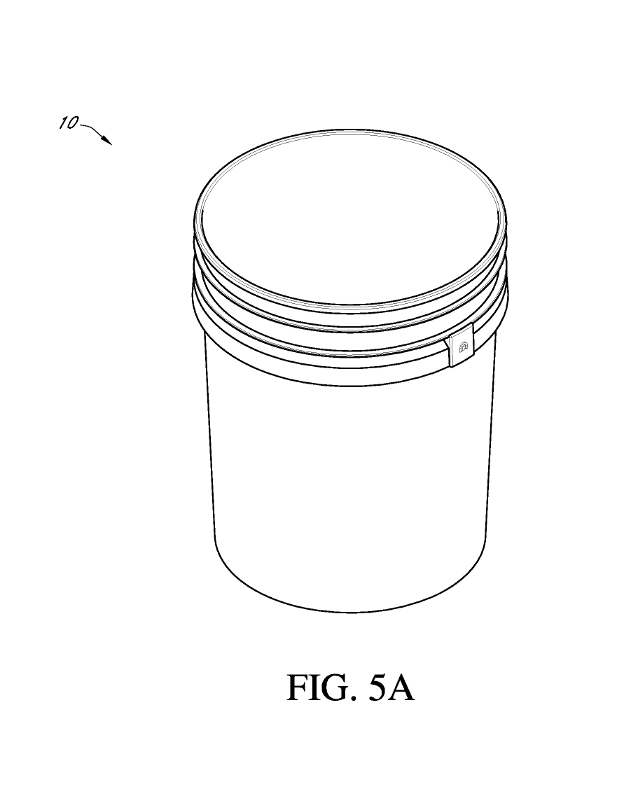

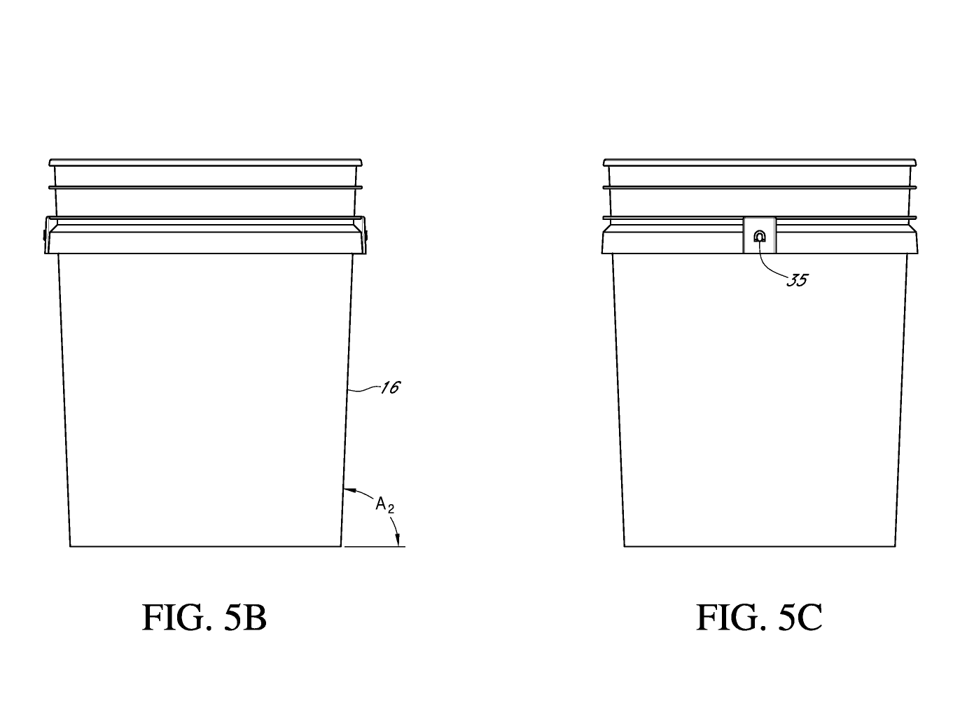

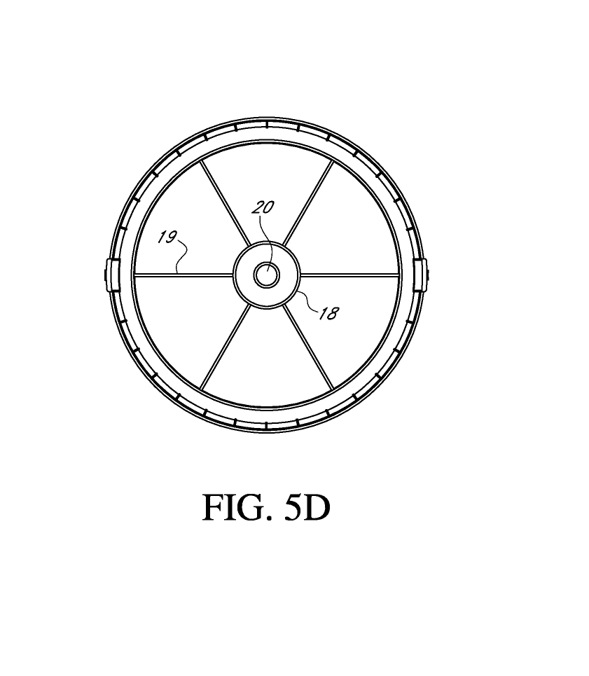

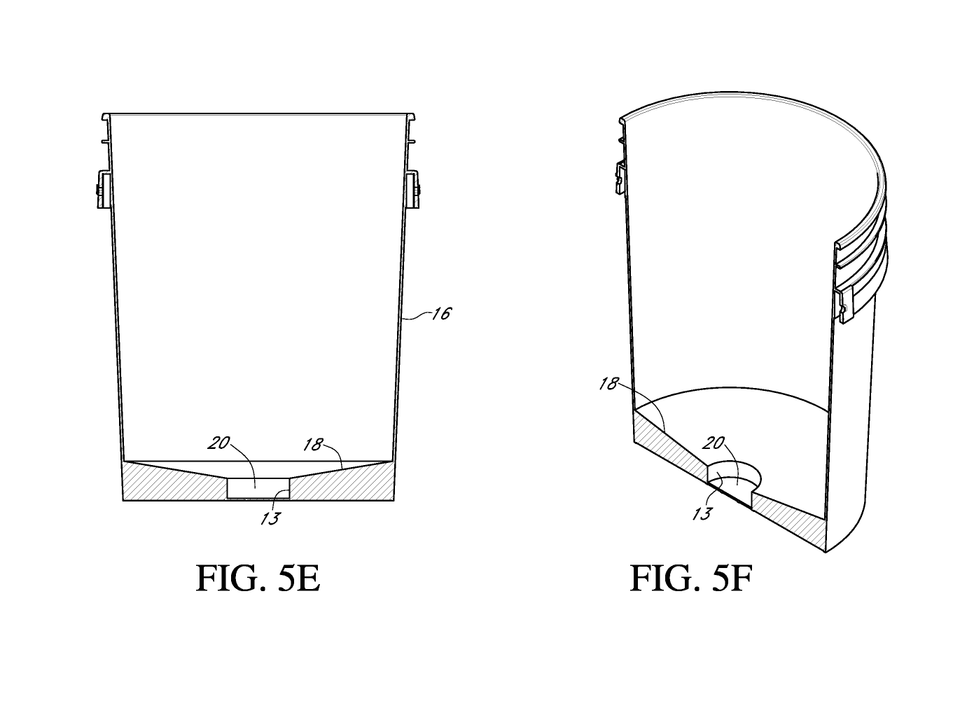

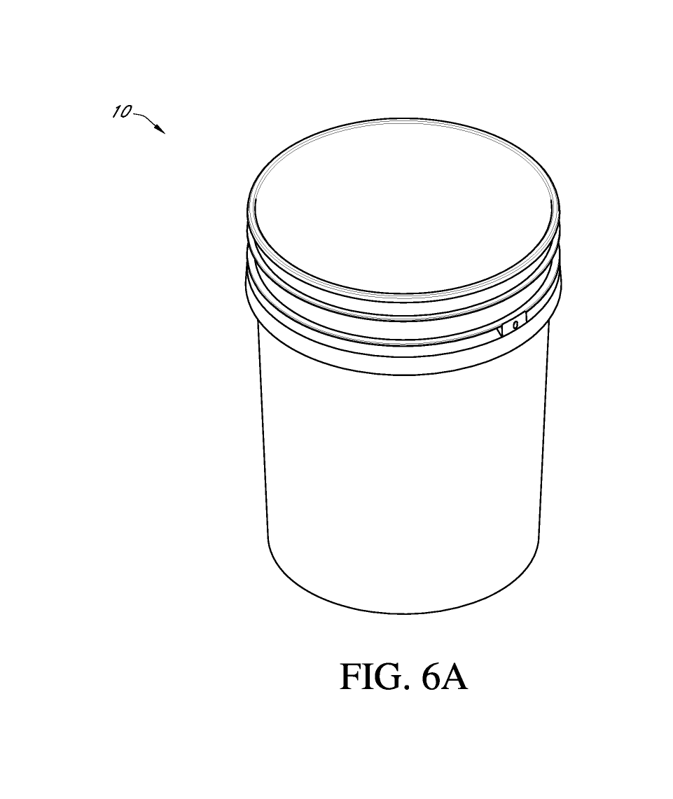

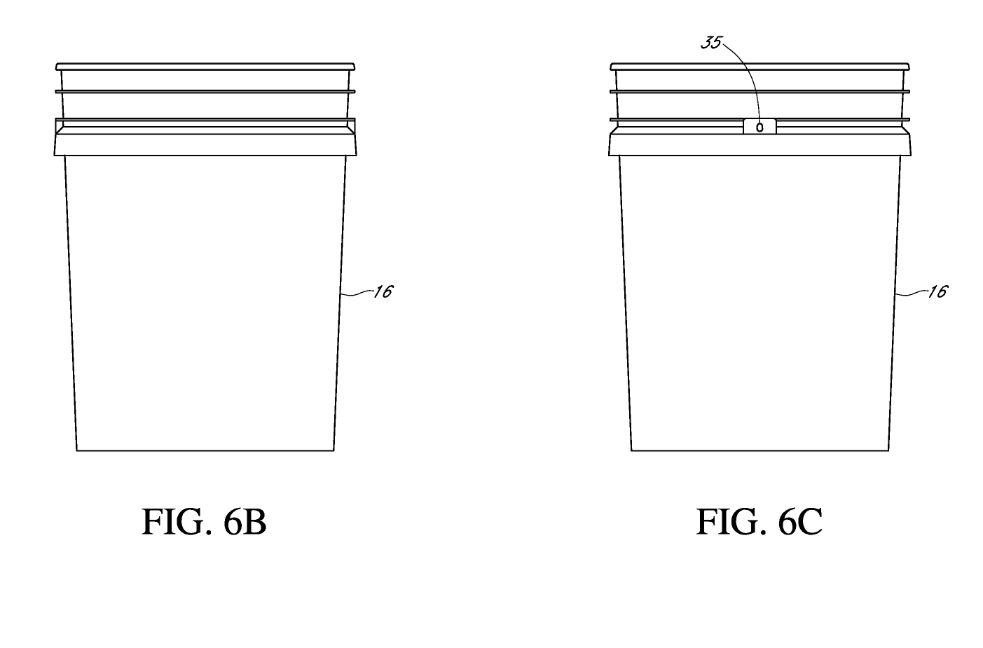

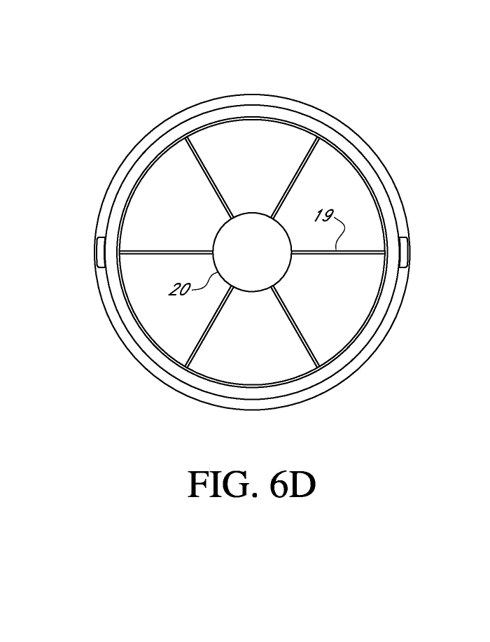

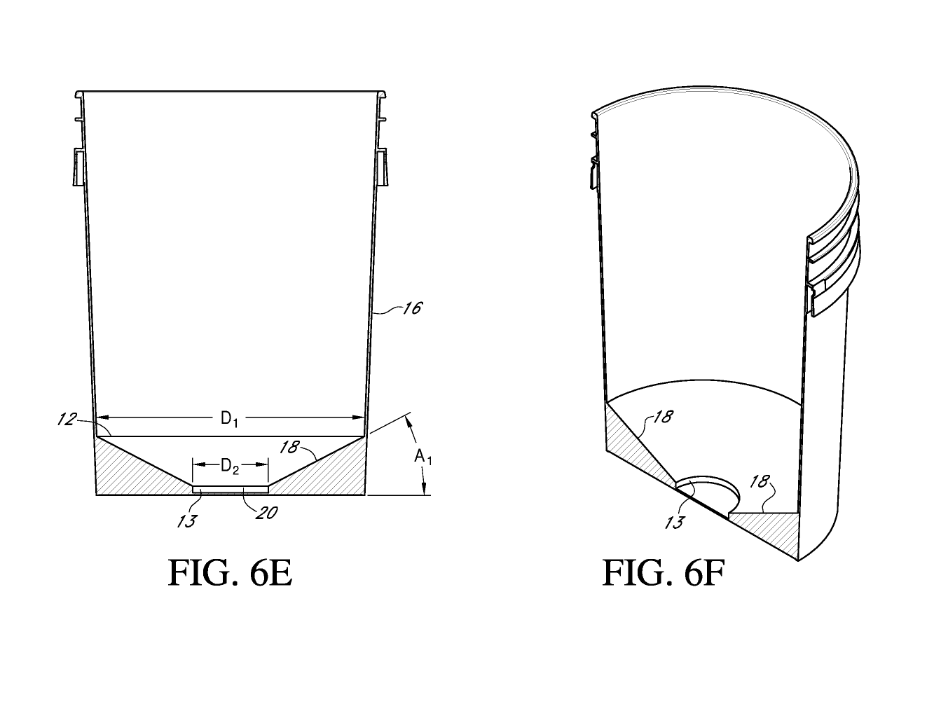

FIGS. 5A-5F and FIGS. 6A-6F illustrate alternate embodiments of bucket 10. Angle A₁ between sides 18 and center portion 20 is adjusted to a predetermined slope of sides 18. Angle A₂ of sidewall 16 and surface 39 can be varied.

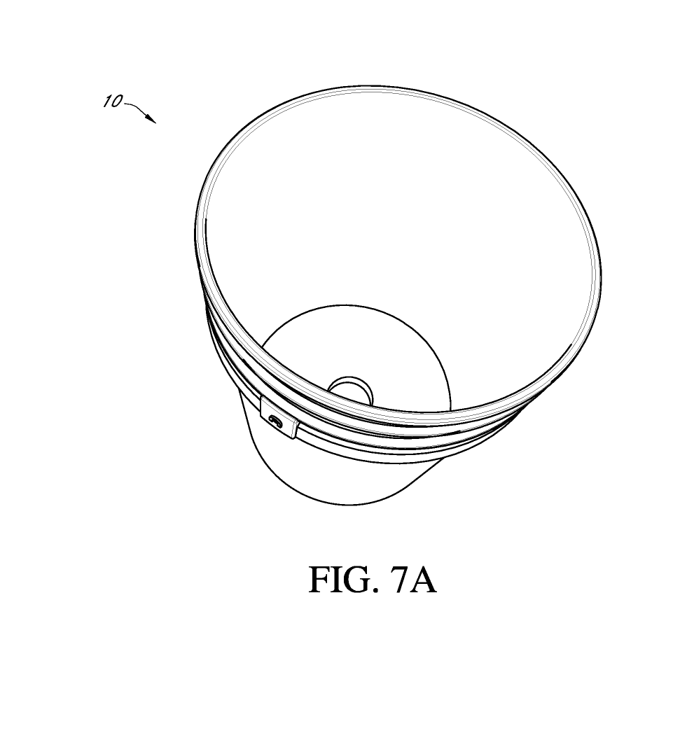

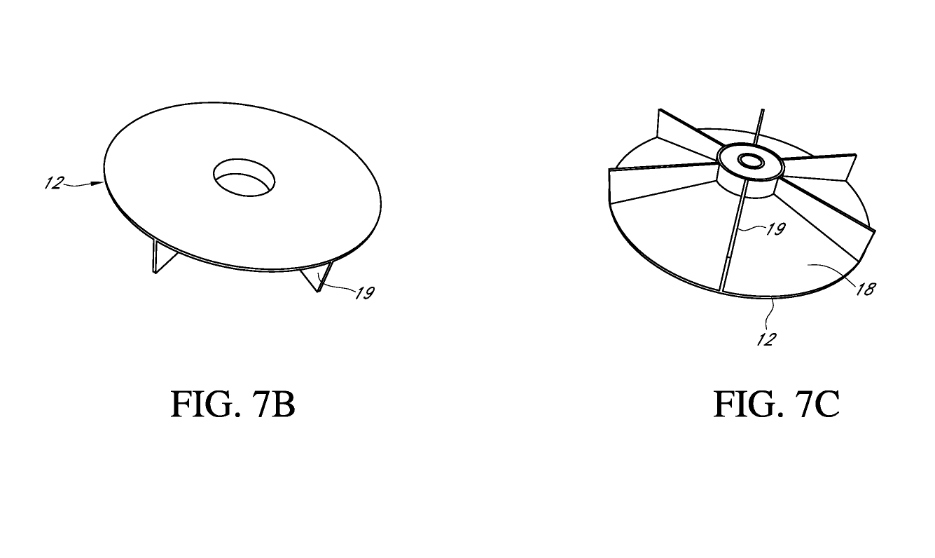

FIGS. 7A-7C illustrate bucket 10 including removable funnel 12. Funnel 12 can snap fit into bucket 10. Supports 19 support sides 18 of funnel 12.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A bucket comprising:
a funnel positioned within said bucket adjacent a bottom of said bucket, said funnel being removably or permanently attached to said bucket, wherein said funnel is adapted to direct a received material downwardly to a center section of the bottom of the bucket.

2. The bucket of claim 1 wherein said sides of said funnel slope downwardly to a cylindrical center portion.

3. The bucket of claim 2 wherein a diameter of said center portion is smaller than a diameter of an upper portion of said funnel.

4. The bucket of claim 1 wherein said funnel has a conical shape.

5. The bucket of claim 1 wherein said funnel has a frusto conical shape.

6. The bucket of claim 1 wherein said funnel is integral with said bucket.

7. The bucket of claim 1 further comprising a handle attached to an upper portion of the bucket and a hand grip coupled to said handle.

8. The bucket of claim 7 wherein ends of said handle are received in apertures of said bucket for coupling said handle to said bucket.

9. The bucket of claim 1 wherein said bucket is substantially a five gallon bucket.

10. The bucket of claim 1 wherein an angle between said sides of said funnel and said center portion is adjusted to determine a predetermined slope of said sides.

11. In combination with a siphon, a bucket comprising:
a funnel positioned within said bucket adjacent a bottom of said bucket, said funnel being removably or permanently attached to said bucket, wherein said funnel is adapted to direct a received material downwardly to a center section of the bottom of the bucket and said siphon being removably attached to said central section of the bottom of said bucket.

12. The combination of claim 11 wherein said sides of said funnel slope downwardly to a cylindrical center portion.

13. The combination of claim 12 wherein a diameter of said center portion is smaller than a diameter of an upper portion of said funnel.

14. The combination of claim 11 wherein said funnel has a conical shape.

15. The combination of claim 11 wherein said funnel has a frusto conical shape.

16. The combination of claim 11 wherein said funnel is integral with said bucket.

17. The combination of claim 11 further comprising a handle attached to an upper portion of the bucket and a hand grip coupled to said handle.

18. The combination of claim 17 wherein ends of said handle are received in apertures of said bucket for coupling said handle to said bucket.

19. The combination of claim 11 wherein said bucket is substantially a five gallon bucket.

20. The bucket of claim 11 wherein an angle between said sides of said funnel and said center portion is adjusted to determine a predetermined slope of said sides.
